(19) United States
(12) Patent Application Publication
(10) Pub. No.: US 2009/0106964 A1
(43) Pub. Date: Apr. 30, 2009

(54) Automatic Device for the Production of Metal Frameworks

(76) Inventor: Ignacio Segura Mecho, Mascarell (Castellon) (ES)

Correspondence Address: WENDEROTH, LIND & PONACK, L.L.P., 1030 15th Street, N.W.,, Suite 400 East, Washington, DC, 20005-1503, US

(21) Appl. No.: 11/922,322

(22) PCT Filed: Jun. 9, 2006
(86) PCT No.: PCT/ES2006/000340

§ 371 Date: Aug. 7, 2008

(30) Foreign Application Priority Data
Jun. 17, 2005 (ES) P200501479

(51) Int. Cl. B25B 27/14

(52) U.S. Cl. 29/281.6

(57) ABSTRACT

The invention relates to an automatic device for the production of metal frameworks. The inventive device first places an assembly of longitudinal metal bars (5) belonging to a framework in horizontal planes and subsequently positions stirrups (4) around said bars at pre-determined intervals. The invention essentially comprises an assembly of bridge structures (1) which are defined by pairs of telescopic posts (6) having end segments from which opposing pairs of horizontal telescopic arms (7) extend, said arms comprising ends segments (9) which support the longitudinal bars (5) of the framework in order subsequently to receive the corresponding stirrups. The stirrups (4) are first disposed on a table (3) which travels along guide rails (2) that are housed centrally between the legs (6) beneath the arms (7), such that as the table (3) advances it positions the stirrups (4) on the longitudinal bars (5) and subsequently solders same at the contact points with the different bars.

### OBJECT OF THE INVENTION

As stated in the title of this descriptive specification, the present invention relates to a device for the automatic production of metal frameworks, the purpose of which is to form a device that will permit the automatic production of metal frameworks.

It has a dual task, on the one hand that of correctly positioning the metal bars making up the frameworks and on the other the transportation and positioning of the stirrups defining the frameworks, the latter and the former being joined afterwards by means of welding.

So, the inventive device is intended for producing metal frameworks which are then used in construction, being essentially applicable to columns and walls, for example.

### PRIOR ART OF THE INVENTION

There currently exist devices for the production of metal frameworks, some of which facilitate the operation of welding the stirrups to the bars, though the problem of arranging the bars along with the stirrups for the correct production of the frameworks remains unsolved.

There also exist other devices intended for the production of frameworks, though in these cases the inventions are focused on two specific types of framework, without reaching the point of developing a general purpose device as is proposed in the novel invention.

On account of all this, metal frameworks for concrete are usually produced manually by fitting the stirrups to longitudinal bars and securing them to the latter with a great deal of patience by means of wire.

This manual work is excessively slow and costly, since the stirrups have to be distributed on the bars in such a way that they remain spaced out, with a separation that is determined by the manufacturing plans.

In the same way, there exist automatic devices which permit the bars making up the framework to be positioned at the corresponding separation according to the manufacturing plans. Nevertheless, this equipment fails to solve the problem of having to locate the stirrups around the bars, nor that of their arrangement within the frameworks.

### DESCRIPTION OF THE INVENTION

With the aim of achieving the objectives and avoiding the drawbacks mentioned in the above paragraphs, the invention proposes a device for the production of metal frameworks characterised in that it comprises an alignment of bridge structures, beneath which there exists a pair of parallel guides where a table device is provided holding some stirrups in order to locate them strategically around the longitudinal bars arranged in at least two heights, so that they can then be welded to them afterwards.

Each bridge structure is characterised in that it comprises two vertical telescopic posts and two pairs of horizontal arms facing each other two by two, also with a telescopic arrangement, in such a way that the longitudinal bars of the framework will rest on the end sections of the arms at two different heights depending on the dimensions and the framework to produce.

The arms incorporate a height adjustment, essentially in order to vary the relative distance between each pair of arms according to the dimensions of the framework that it is wished to obtain, at the same time as said arms are connected in the upper end sections of the posts.

The table device is characterised in that it comprises an upper platform which includes two parallel vertical plates associated by means of an adjustment mechanism in order to vary the relative distance between them, with the aim of adapting them to the dimensions of the stirrups, which are located precisely between that pair of plates, being arranged one after another until the precise number is achieved for then distributing them perimetrically and around the two groups of bars arranged in horizontal parallel planes, being spaced out from each other by an amount determined beforehand.

This distribution is done by means of advancing the table device along the guide rails, in such a way that as it advances, it makes intermittent stops were appropriate and deposits a stirrup in the precise location of the bars, enveloping them, in such a way that once the table device has traversed the entire length of the bars, positioning all the stirrups, those stirrups will then proceed to be joined to the bars by means of welding the contact points.

The table device is also characterised in that it incorporates two rear stops which serve to maintain the position of the stirrups.

These rear stops are complemented with a thrust mechanism which presses uniformly on the group of stirrups against the said rear stops.

There also exists a positioning mechanism which permits the stirrups to be located at the intended intervals along the longitudinal bars.

The table device incorporates a further mechanism for adjustment in order to locate the bars and angled bases at an inclined position when the load of the stirrups is received.

During the advance of the table device and when it reaches each bridge structure, the telescopic arms thereof withdraw and place themselves in a folded position, in such a way that the bars cease to rest for a period of time on that specific pair of arms until the table device completely exceeds the vertical plane of the respective bridge structure, returning afterwards to the unfolded active position in which the bars again rest on the end sections of the arms.

Said lower base furthermore incorporates a characteristic first group of sensors corresponding to each bridge structure so that the arms fold every time the table device reaches each of the said bridge structures.

The lower base incorporates a second characteristic group of sensors in the actual guides for at all times controlling the exact position of the table, and thereby locate each stirrup in the desired positions determined beforehand along the longitudinal bars resting on the successive arms.

Below, in order to facilitate a better understanding of this specification and forming an integral part thereof, some figures are attached in which, on an illustrative rather than limiting basis, the most characteristic details of the invention have been represented.

### BRIEF DESCRIPTION OF THE DRAWINGS

FIG. 1.—Shows a perspective view of the automatic device for production of metal frameworks, the object of the invention.

FIG. 2.—Shows a profile view of the inventive device.

FIG. 3.—Shows a perspective view of the application of the inventive device.

FIG. 4.—Shows a view of part of the device. This basically concerns one of the various vertical telescopic posts, from whose highest section extends a pair of horizontal arms also with telescopic adjustment.

FIG. 5.—Shows a perspective view of a table device adjustable in height and with various mechanisms. Said device is responsible for receiving and facilitating the location of some stirrups along some longitudinal bars previously arranged in horizontal planes forming part of the frameworks.

FIG. 6.—Shows another perspective view of the table.

FIG. 7.—Shows a front view of the table.

FIG. 8.—Shows a view of a mechanism for hauling the table along some lower guide rails.

FIG. 9.—Shows a perspective view of the end sections of the telescopic arms incorporating certain elements for grasping and locating the longitudinal bars.

FIG. 10.—Shows a perspective view of a relative adjustment mechanism between pairs of arms.

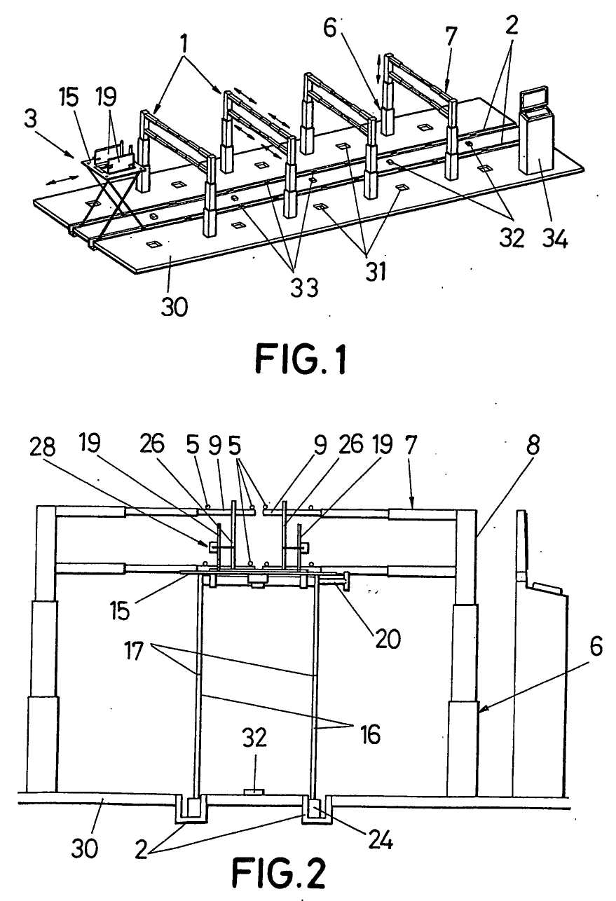

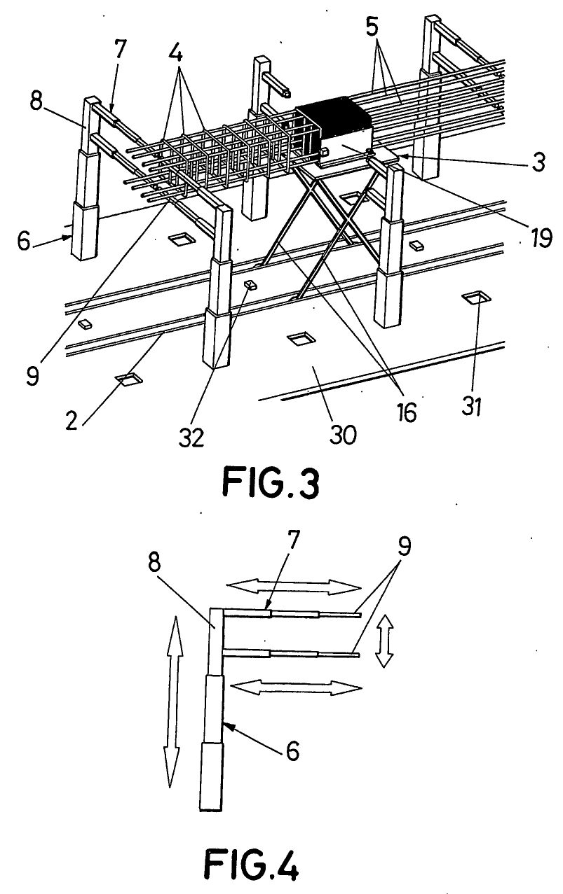

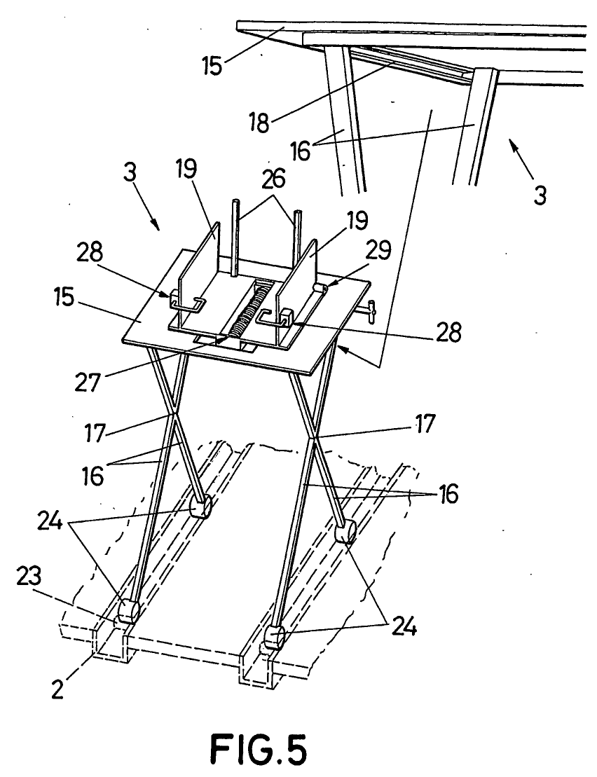

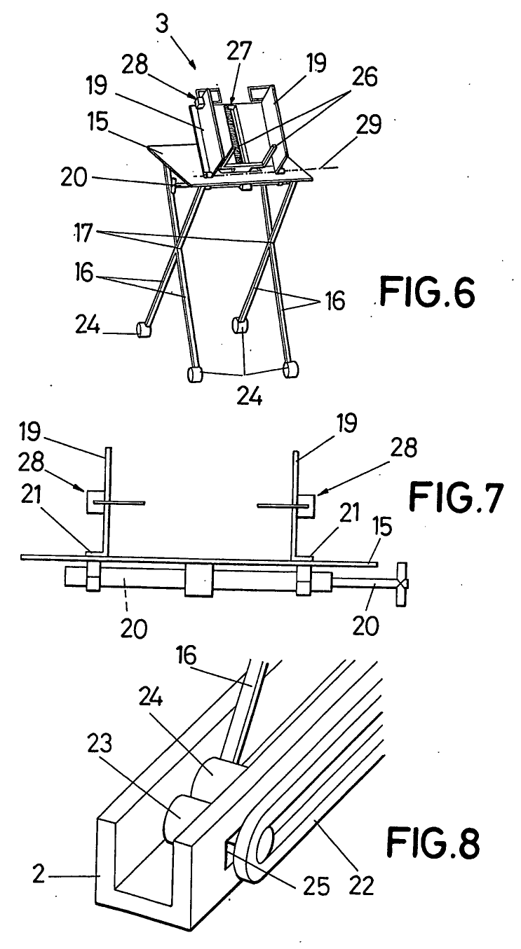

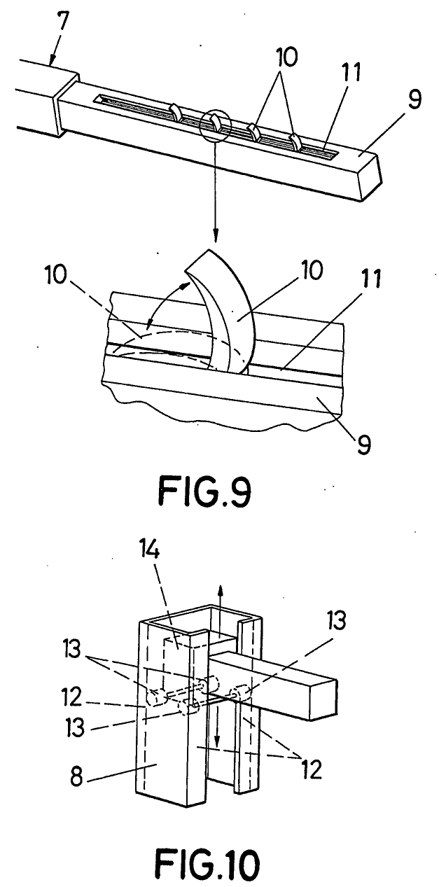

### DESCRIPTION OF THE PREFERRED FORM OF EMBODIMENT

Considering the numbering adopted in the figures, the automatic device for production of frameworks is defined starting from an alignment of bridge structures 1, arranged centrally beneath which are a pair of parallel continuous guide rails 2 on which travels a table device 3, adjustable in height.

This table device 3 receives some stirrups 4 in order afterwards to locate them strategically around two groups of longitudinal bars 5 positioned in two different planes, so as afterwards to weld said stirrups 4 to the bars 4 at their contact points, all this by means of an automatic process governed from a control cabinet 34.

The bridges structures 1 comprise a pair of vertical telescopic posts 6 with height adjustment and two pairs of horizontal telescopic arms 7 facing each other two by two, which extend from the uppermost end sections 8 of the posts 6. The longitudinal bars 5 rest on the end sections 9 of the arms 7 at two different heights according to the dimensions of the framework to produce.

So, first a group of bars will be laid on the end sections 9 of the lowermost arms 7 with the upper arms 7 remaining folded. The upper arms are then arranged in the unfolded position in order to locate the second group of bars 5 on the end sections 9 of the upper arms 7.

These end sections 9 of the horizontal arms 7 incorporate certain retractable gripping hooks 10 in order to grasp and locate the bars correctly at the desired distance when they are resting of those end sections 9. These gripping hooks 10 extend from an elongated channel 11, in such a way that the adjustment in distance of the hooks 10 can be done either manually or automatically.

The gripping by means of the respective hooks 10 can be done in different positions in such a way that they can be hidden or otherwise, both for withdrawing the arms 7 and as a function of the number of bars 5 which the framework is going to have. All the movements of the grips will be able to be done manually or automatically.

The arms 7 incorporate a height adjustment mechanism for being able to vary the relative distance between each pair of arms 7, according to the dimensions of the framework it is wished to obtain.

This adjustment mechanism basically consists of some rails 12 located in the end sections 8 of the vertical posts 6, in such a way that travelling in those rails 12 are some guide elements 13 coupled to a support 14 integral with each telescopic arm 7. The vertical displacement of the support 14 of each arm 7 is done by means of any suitable motor element.

The table device 3 in principle comprises an upper platform 15 supported by two pairs of crossed legs 16 with a linkage 17 at their cross-over points so that the height of the table can be varied according to need. In order to make the height adjustment possible, provided in the linkage of the legs with the platform 15 via its lower face are some parallel guides 18 which permit the upper ends of the legs 16 to slide until the table 3 reaches the desired height.

Moreover, the upper platform 15 of the table 3 incorporates two parallel plates 19 in vertical planes associated by means of a worm gear 20 provided beneath the platform 15 in order to adjust the distance between them so as to adapt them to the dimensions of the stirrups 4, which are located precisely between that pair of plates 19, being arranged one after another in successive vertical planes until the precise number is achieved for then distributing them perimetrically and around the two groups of bars 5 arranged in horizontal parallel planes, being spaced out from each other by an amount determined beforehand.

This distribution is done by means of advancing the table device 3 along the guide rails 2, in such a way that as it advances, it makes intermittent stops where appropriate and deposits a stirrup 4 in the precise location of the bars 5 enveloping them, in such a way that once the table device 3 has traversed the entire length of the bars 5, positioning all the stirrups 4, those stirrups 4 will then proceed to be joined to the bars 5 by means of welding the contact points of these with respect to the stirrups 4. The parallel plates 19 includes some angled base 21.

The displacement of the table assembly 3 is done by means of a hauling mechanism which basically consists of a chain 22 associated with some rollers 23 fitting in the guide channels 2, where some wheels 24 of the table 3 are also to be found, which take the thrust of the rollers 23 when the hauling mechanism acts in order to displace the table 3.

The guide channels 2 incorporate some lateral grooves 25 in which fit some intermediate sections of the rollers 23, which are connected to the chain 22 from the outside of the guide channels 2.

The table device 3 also incorporates two rear stops 26 which extend perpendicularly from the angled bases 21 and serve to maintain the position of the stirrups 4.

These rear stops 26 are complemented with a thrust mechanism 27 which presses uniformly on the group of stirrups 4 against the said rear stops 26.

There also exists a positioning mechanism 28 which permits the stirrups 4 to be able to be located at the intended intervals along the longitudinal bars 5.

The table device 3 incorporates a further mechanism for adjustment in order to locate the plates 19 and angled bases 21 at an inclined position when the load of the stirrups 4 is received from a raised zone above that upper platform 15 and parallel plates. For this, the two sets of plates 19 and angled bases 21 are linked by means of a rear hinge 29 in the platform 15 of the table 3.

The location of the stirrups 4 between the parallel plates 19 of the upper platform 15 can be done manually as well as automatically.

The positioning mechanism 29 is associated with the front part of those two parallel plates 19, in that case remaining contiguous with the load zone in order later on to permit and facilitate the positioning of the stirrups 4 along the longitudinal bars 5.

During the advance of the table device 3 and when it reaches each bridge structure 1, the telescopic arms 7 thereof withdraw and place themselves in a folded position, in such a way that the bars 5 cease to rest for a period of time on that specific pair of arms 7 until said table device 3 completely exceeds the vertical plane of the respective bridge structure 1, returning afterwards to the unfolded active position in which the bars 5 again rest on the end sections of the arms 7.

The guide rails 2 are arranged on a lower base 30 which also incorporates two alignments of connection elements 31 of the vertical posts 6.

Said lower base 30 furthermore incorporates a characteristic first group of sensors 32 corresponding to each bridge structure 1 so that the arms 7 fold every time the table device 3 reaches each of the said bridge structures 1. These sensors are specifically located between the guides by way of rails 2.

The lower base 30 incorporates a second characteristic group of sensors 33 in the actual guides 2 for at all times controlling the exact position of the table 3, and thereby locate each stirrup 4 in the desired position determined beforehand along the longitudinal bars 5 resting on the successive arms 7.

The production of the framework is a totally automatic process of high precision and good functioning governed from the control cabinet 34 provided for example in the zone of the lower base 30, as shown in the figures.

1-10. (canceled)

11. AUTOMATIC DEVICE FOR THE PRODUCTION OF METAL FRAMEWORKS, intended for joining groups of longitudinal bars by means of a succession of stirrups via their contact points, which comprises an alignment of bridge structures (1) consisting of pairs of vertical posts (6) and at least pairs of horizontal arms (7) facing each other two by two, the end sections of the horizontal arms having longitudinal bars (5) which form part of a framework, characterised in that
the pairs of vertical posts (6) and pairs of horizontal arms (7) are telescopic, the respective pairs of telescopic arms (7) folding in order to permit the passage of a table device (3), afterwards unfolding once the bridge structure (1) has passed through,
the pairs of horizontal telescopic arms (7) face each other two by two and extend from the end sections of the vertical posts (6),
a middle part of the alignment of bridge structures (1) comprises a table device (3) carrying a succession of stirrups (4), interior to the bridge structures (1), which are conveyed on and are automatically guided by some guide rails (2) located in a plane below the level of the ground and which run centrally below the bridge structures (1); in such a way that, during the advance of the table device (3), it makes intermittent stops in order to locate respective stirrups on the group of longitudinal bars (5) perimetrically around them.

12. AUTOMATIC DEVICE FOR THE PRODUCTION OF METAL FRAMEWORKS, according to claim 11, characterised in that it includes a first group of sensors (32) at the height of each bridge structure (1), said group of sensors (32) causing the respective pairs of arms (7) to fold in order to permit the passage of the table device (3), afterwards unfolding once the bridge structure has passed through (1).

13. AUTOMATIC DEVICE FOR THE PRODUCTION OF METAL FRAMEWORKS, according to claim 11, characterised in that it incorporates a second group of sensors (33) located essentially in a part of the guide rails (2), these sensors being intended for locating and depositing strategically the stirrups along the longitudinal bars (5) in line with the advance of the table device (3) along the guide rails (2).

14. AUTOMATIC DEVICE FOR THE PRODUCTION OF METAL FRAMEWORKS, according to claim 11, characterised in that the arms (7) incorporate a height adjustment mechanism defined on the basis of some rails (12) located in the end sections (8) of the posts (6), at the same time as conveying in those rails (12) some guide elements (13) coupled to some supports (14) integral with the telescopic arms (7), which can be displaced up and down by means of motor elements.

15. AUTOMATIC DEVICE FOR THE PRODUCTION OF METAL FRAMEWORKS, according to claim 11, characterised in that the end sections (9) of the telescopic arms (7) where the longitudinal bars (5) of the corresponding framework rest incorporate some retractable hooks (10) for gripping the longitudinal bars (5), these hooks furthermore serving as alignment elements for the bars (5); said hooks (10) extending from some elongated channels (11).

16. AUTOMATIC DEVICE FOR THE PRODUCTION OF METAL FRAMEWORKS, according to claim 11, characterised in that it incorporates a hauling mechanism for the table device (3) by means of some rollers (23) which are anchored by a chain (22) which performs the entire travel of the guide rails (2), the rollers (23) pushing on some wheels (24) of the table device (3) located within the guide rails (2).

17. AUTOMATIC DEVICE FOR THE PRODUCTION OF METAL FRAMEWORKS, according to claim 11, characterised in that the table device (3) is adjustable in height and includes two pairs of crossed legs (16) which are articulated via their cross-over points (17), the lower ends of said legs ending in the wheels (24) of the table device (3), said wheels located in the guide rails (2), while the upper ends fit into and travel along a pair of parallel guides (18) of an upper platform (15).

18. AUTOMATIC DEVICE FOR THE PRODUCTION OF METAL FRAMEWORKS, according to claim 17, characterised in that the upper platform (15) of the table device (3) incorporates above itself a support for stirrups (4) coupled by an articulation via its rear part by means of a hinge (29), its width being adjustable according to the width of the stirrups (4), at the same time as it can be located with different inclinations; the support including some rear stops (26), a thrust mechanism (27) which presses on the stirrups against the stops (26) and a positioning mechanism (28) which permits the stirrups to be located at the intended intervals along the longitudinal bars (5), enveloping them.

19. AUTOMATIC DEVICE FOR THE PRODUCTION OF METAL FRAMEWORKS, according to claim 18, characterised in that the support for the stirrups (4) includes two parallel plates (19) with some lower elbowed bases (21) associated with a worm gear mechanism for varying the width of the plates (19) of the support according to the dimensions of the said stirrups (4).

20. AUTOMATIC DEVICE FOR THE PRODUCTION OF METAL FRAMEWORKS, according to claim 11, characterised in that it includes a lower base (30) where the first group of sensors (32) is located corresponding to the bridge structures (1), and the guide rails (2), said base (30) furthermore including two alignments of connection elements (31) of the telescopic posts.

21. AUTOMATIC DEVICE FOR THE PRODUCTION OF METAL FRAMEWORKS, according to claim 12, characterised in that it incorporates a second group of sensors (33) located essentially in a part of the guide rails (2), these sensors being intended for locating and depositing strategically the stirrups along the longitudinal bars (5) in line with the advance of the table device (3) along the guide rails (2).

22. AUTOMATIC DEVICE FOR THE PRODUCTION OF METAL FRAMEWORKS, according to claim 12, characterised in that the arms (7) incorporate a height adjustment mechanism defined on the basis of some rails (12) located in the end sections (8) of the posts (6), at the same time as conveying in those rails (12) some guide elements (13) coupled to some supports (14) integral with the telescopic arms (7), which can be displaced up and down by means of motor elements.

23. AUTOMATIC DEVICE FOR THE PRODUCTION OF METAL FRAMEWORKS, according to claim 12, characterised in that the end sections (9) of the telescopic arms (7) where the longitudinal bars (5) of the corresponding framework rest incorporate some retractable hooks (10) for gripping the longitudinal bars (5), these hooks furthermore serving as alignment elements for the bars (5); said hooks (10) extending from some elongated channels (11).

24. AUTOMATIC DEVICE FOR THE PRODUCTION OF METAL FRAMEWORKS, according to claim 12, characterised in that it incorporates a hauling mechanism for the table device (3) by means of some rollers (23) which are anchored by a chain (22) which performs the entire travel of the guide rails (2), the rollers (23) pushing on some wheels (24) of the table device (3) located within the guide rails (2).

25. AUTOMATIC DEVICE FOR THE PRODUCTION OF METAL FRAMEWORKS, according to claim 12, characterised in that the table device (3) is adjustable in height and includes two pairs of crossed legs (16) which are articulated via their cross-over points (17), the lower ends of said legs ending in the wheels (24) of the table device (3), said wheels located in the guide rails (2), while the upper ends fit into and travel along a pair of parallel guides (18) of an upper platform (15).

26. AUTOMATIC DEVICE FOR THE PRODUCTION OF METAL FRAMEWORKS, according to claim 12, characterised in that it includes a lower base (30) where the first group of sensors (32) is located corresponding to the bridge structures (1), and the guide rails (2), said base (30) furthermore including two alignments of connection elements (31) of the telescopic posts.
